(19) United States
(12) Patent Application Publication
(10) Pub. No.: US 2005/0089151 A1
(43) Pub. Date: Apr. 28, 2005

(54) Method and system for enabling and managing telephone number portability

(76) Inventor: John Ming-Chuan Han, Hacienda Heights, CA (US)

Correspondence Address: GRAFFITI PROMOTIONS, LLC, 827 WINDSOR ROAD, ARNOLD, MD, 21012, US

(21) Appl. No.: 10/693,151

(22) Filed: Oct. 24, 2003

(51) Int. Cl. G06F 17/60

(52) U.S. Cl. 379/114.27

(57) ABSTRACT

A method for efficiently enabling and managing telephone number portability based on a three step process that is adaptable for use in wireline to wireless, wireless to wireless, new wireless, and sale or auction transactions of portable phone numbers. A three step process consisting of (1) the validation of a buyer or seller of a portable number, (2) the actual purchase process of obtaining or selling a portable number, and (3) the transport process of delivering a compatible phone and carrier plan to a purchaser is described. Additionally the three processes of the broad method are described in detail for both sellers and buyers which to sell or purchase portable phone numbers taking into consideration such factors as phone compatibility, carrier requirements, fees, and outstanding balances associated with portable numbers that are for sale. A sale or auction format for selling or purchasing portable numbers is also described.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### TECHNICAL FIELD OF THE INVENTION

The present invention relates generally to enabling phone number portability of landline to cellular and cellular to cellular networks among multiple carriers and the assignment of telephone numbers therein.

### BACKGROUND OF THE INVENTION

Past US phone markets did not allow phone number portability and required consumers and businesses to change numbers when moving or switching phone service providers. This also applies to consumers and businesses who wish to convert current landlines to wireless. The non-existence of phone number portability in combination with unsatisfactory services has lead to increased dissatisfaction. Consumers and businesses who wish to switch phone service providers to take advantage of better services, competitive pricing, or increased airtime suffer since phone numbers must be changed when switching to a different service provider.

As discussed in U.S. Pat. No. 6,611,831 issued to Dunn, et al. the lack of phone number portability created a substantial disadvantage for companies in a number of ways. The lack of phone number portability created an undue hardship on commercial users since any change of phone carriers would affect their phone and fax numbers. New stationary was necessary and all advertisements would have to be changed or updated to reflect the new contact numbers. Additionally, companies who obtained special numbers which took advantage of the letter sub-sets which appear on the numbers of a phone keypad would lose the good will associated with number if they changed carriers and had to forfeit the number.

In light of the previously mentioned market conditions the United States Congress enacted the Telecommunications Act of 1996, which specifically required telephone number portability. This legislation required that phone service providers enable number portability and allow consumers who wish to change providers the ability to take their number with them for use on the new providers' network. This new number portability requirement has created a new business market niche that the present invention is designed to bring efficiently and easier use for both consumers and businesses.

Phone number portability will increase competition in the telecommunications sector as carriers will strive to retain their client base by offering more competitive prices and plans. Individual and commercial users will have the ability to change carriers since the Telecommunications Act of 1996 has removed the greatest barrier to change with respect to personal and commercial users, the ability to keep their current phone number while changing carriers. This market revolution will create the need for consumers and businesses to sell existing numbers and plans in addition to enabling consumers and businesses to seek specific numbers they might want to use or attach value to for various reasons.

### SUMMARY

The present invention addresses the shortcoming in the prior art with respect to providing a method for creating efficient phone number portability in the marketplace. The present invention in centered on a three-step process that brings efficiency to the phone services industry for both consumers and commercial supplies. The present invention applies the three-step process to the main areas of phone number portability that are: Wireline to Wireless and Wireless to Wireless; New Wireless Portable Numbers; and Wireless Number Auction/Sale.

### BRIEF DESCRIPTION OF THE DRAWINGS

FIG. 1 illustrates the basic three-step method;

FIG. 2 illustrates the wireline to wireless and wireless to wireless validation process;

FIG. 3 illustrates the wireline to wireless and wireless to wireless purchase process;

FIG. 4 illustrates the wireline to wireless and wireless to wireless transport process;

FIG. 5 illustrates the new wireless validation process;

FIG. 6 illustrates the new wireless purchase process;

FIG. 7 illustrates the new wireless transport process;

FIG. 8 illustrates the wireless number auction/sale method;

FIG. 9 illustrates the wireless number auction/sale seller validation process;

FIG. 10 illustrates the wireless number auction/sale buyer validation process;

FIG. 11 illustrates the wireless number auction/sale purchase process;

FIG. 12 illustrates the wireless number auction/sale transport process.

### DETAILED DESCRIPTION OF THE INVENTION

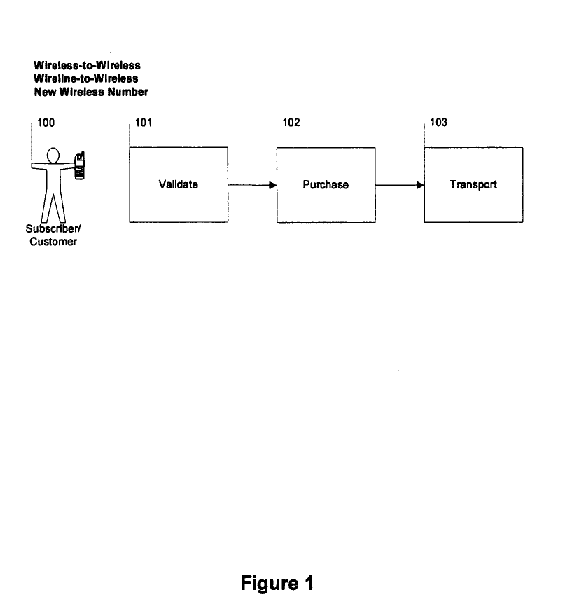

The common three-step method used to bring efficiency and order the new portable phone number market is illustrated in FIG. 1. FIG. 1 represents the three basic steps a consumer (also referred to as a subscriber) should under take when facilitating the transfer of a phone number between wireline and wireless systems; wireless and wireless systems, including the auction/sale of existing numbers; or when subscribing to a new wireless portable number. A subscriber (100) wishing to transfer their existing number between wireline and wireless systems; wireless and wireless systems, including the auction/sale of existing numbers; or obtaining a new portable wireless number should first undergo a validation process (101) personal, provider, and number information. Once the validation process (101) is completed successfully the purchase process (102) where the consumer selects the service provider is completed. Finally, the last step in the process is for the transportation process (103) where the phone number is assigned to the new service provider and the consumer obtains a new, compatible phone if necessary.

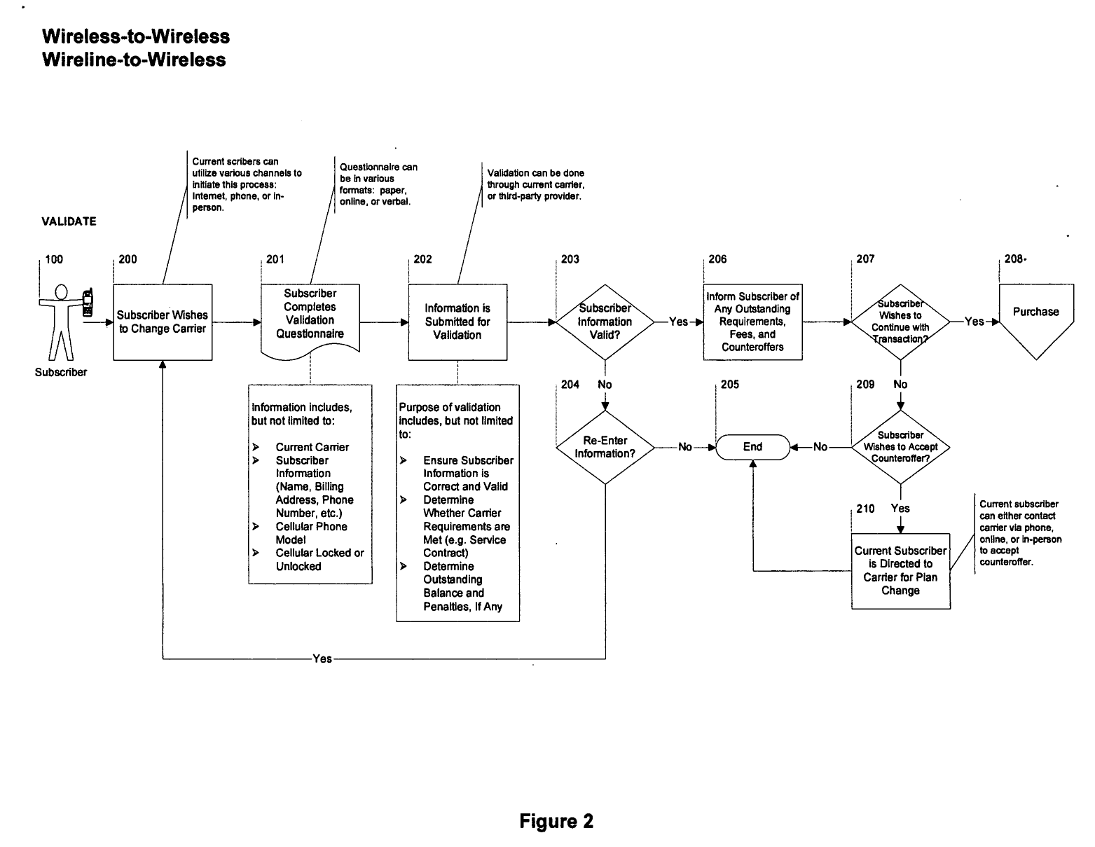

Now referring to FIG. 2 the validation process of the wireline to wireless or wireless to wireless process, just one embodiment of the present invention, is explained. The subscriber (100) first decides to change carriers (200), which can be accomplished by utilizing various channels to initiate the process such as the Internet, phone, or in-person. Next the subscriber completes a validation questionnaire (201), which is offered in various formats such as paper, online, digital, or verbal. The questionnaire includes, but is not limited to, information regarding the subscriber's current carrier, name, billing address, phone number, cellular phone model, and whether the cellular phone is locked or unlocked. This information is then submitted for validation (202) and the subscriber information is validated (203). The purpose of validation includes, but is not limited to, ensuring subscriber information is correct and valid, determine whether carrier requirements are met, and determine outstanding balance and penalties, if any.

If validation is unsuccessful the user must re-enter the information (204) and restart the process or end the process (205). If validation is successful the subscriber is informed of any outstanding requirements, fees, and counteroffers (206). With this information the subscriber must decide whether to continue with the transaction (207) and purchase (208) or end the transaction (205). Additional, the subscriber can elect to accept any potential counter offers (209) and, if elected, the current subscriber is directed to the carrier for plan change (210) which they can contact via phone, online, or in-person to accept the counter offer.

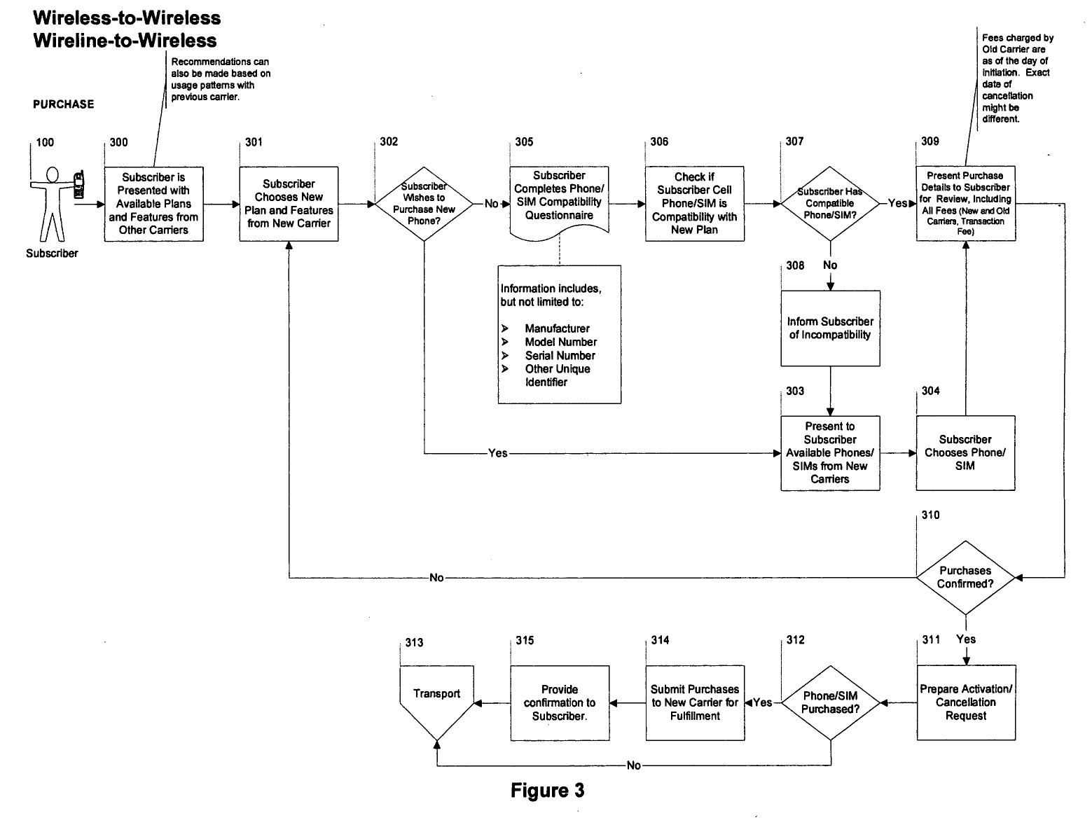

Now referring to FIG. 3 the purchase phase of the wireline to wireless or wireless to wireless process is described. After completion of the validation process the subscriber (100) begins the purchase process by first being presented with available plans and features form other carries (300) with the recommendation being made on usage patters with previous carriers. Next the subscriber chooses a new plan and features from the new carrier (301) and then decides whether to purchase a new phone (302). If the subscriber elects to purchase a new phone they are presented with a list of available phones (303) from the new carrier and then choose their new phone (304). If the subscriber does not elect to purchase a new phone then they must complete a compatibility phone questionnaire (305). The compatibility phone questionnaire includes, but is not limited to information on the manufacturer, model number, serial number, and other unique phone identifiers. Next the subscriber's phone is checked for compatibility with the carrier (306) and a compatibility decision is made (307). If the subscriber's phone is not compatible they are informed (308) and are presented with available phones from the new provider (303). If the subscriber's phone is compatible present purchase details are presented to the subscriber for review (309), which includes new and old carrier transaction fees. The fees charged by the old carrier are as of the day of initiation and the exact cancellation date might be different. Next the purchase is confirmed (310) and the subscriber continues with activation and cancellation request (311) or returns to choose a new plan (301) if they elect not to confirm their current selection. Finally the new phone purchase decision (312) is analyzed and if a new phone is not purchased the method of wireline to wireless or wireless to wireless phone portability proceeds immediate to the transport process (313), but if a new phone is purchased a submission is made to the new carrier to fulfill order (314) and confirmation (315) is provided to the subscriber.

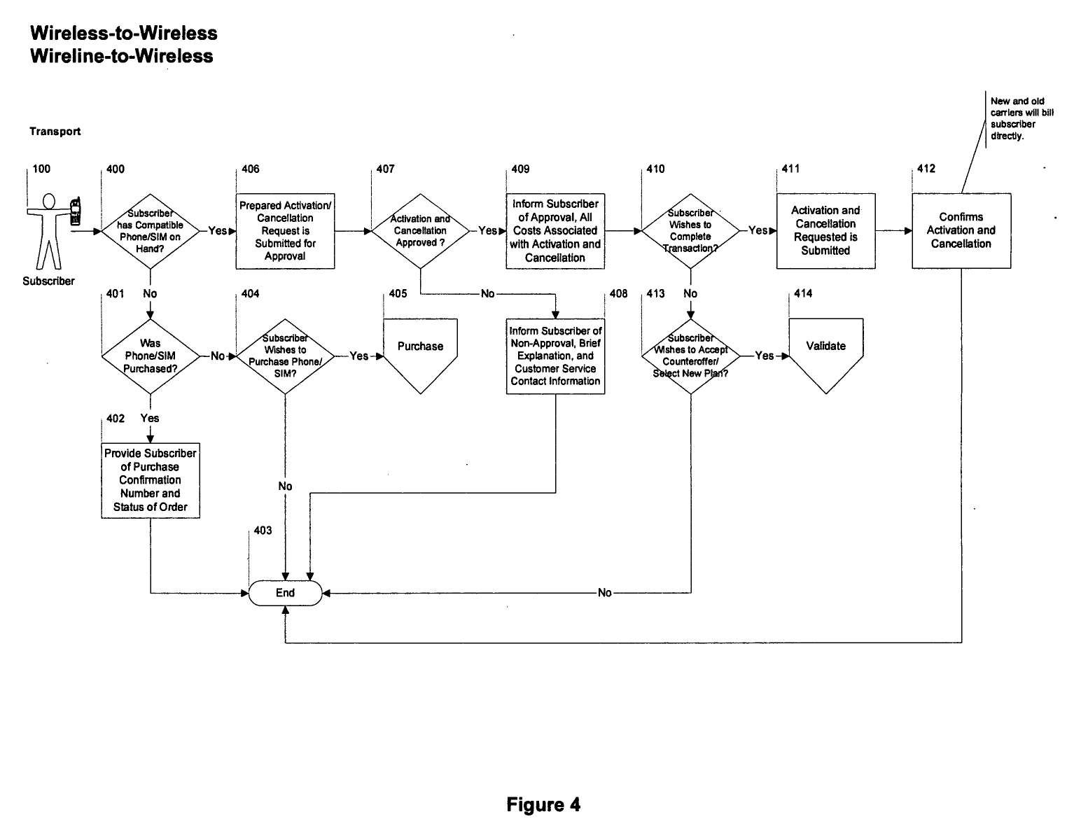

With the purchase process complete the final step is the transport process, which is described in FIG. 4. The transport process starts when the subscriber (100) has a compatible phone on hand (400). If the subscriber does not have the phone on hand they is first asked if they purchased a new phone (401), if they have a confirmation number and order status update (402) is provided and the transport process ends (403) until a phone is received. If the subscriber had not purchased a phone they are asked if they wish to purchase a phone at this point (404). If the subscriber wishes to purchase a phone they are directed to the purchase process (405), but if they choose not to purchase a phone at this time the transport process ends (403).

If the subscriber has a phone the cancellation request is submitted and the activation process begins (406). Next the application and cancellation must be approved (407). If it is not approved the subscriber is informed of the non-approval (408) and the transport process ends (403). If it is approved the subscriber is informed of approval (409) and all costs associated with the transaction.

Next the subscriber must decide whether to complete the transaction (410). If the subscriber elects to complete the transaction the activation and cancellation requests are submitted (411) and a confirmation (412) is generated upon completion and the new and old carriers will bill subscriber directly. If the subscriber elects not to complete the transaction (410) they are still able to accept any counter offers or select a new plan (413). If the subscriber does not wish to accept any other offers then the transport process ends (403), but if a new offer is accepted then the user must return to the validation process (414).

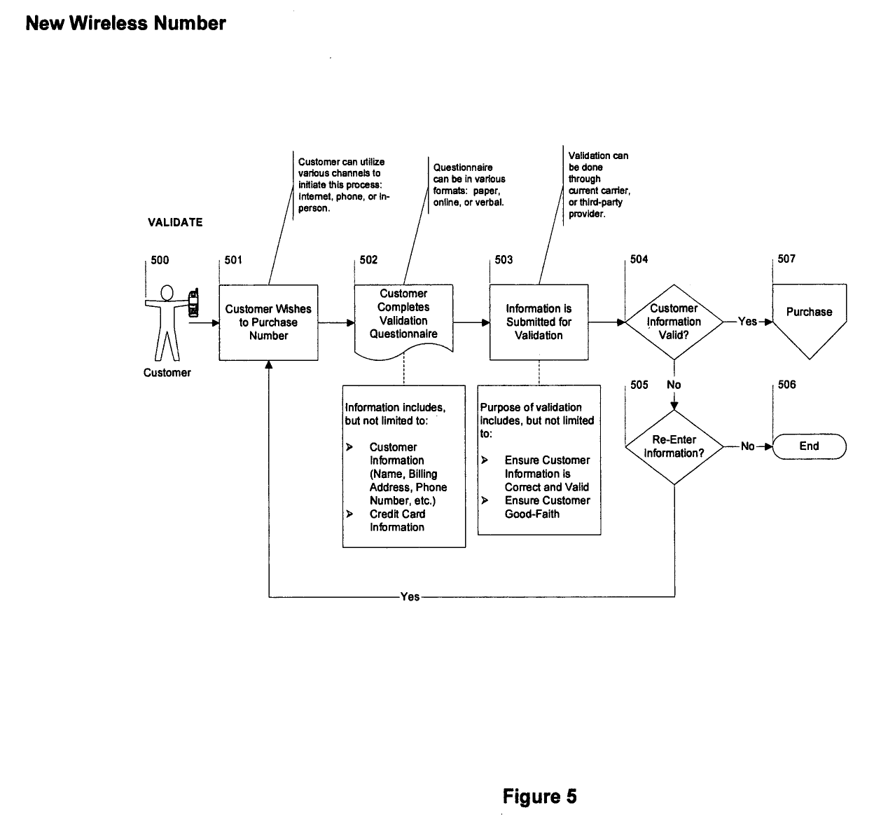

In another embodiment the three-step process is used for new wireless portable numbers. Now referring to FIG. 5 the validation process of the new portable phone number process is explained. The customer (500) first decides to purchase a number (501), which can be accomplished by utilizing various channels to initiate the process such as the Internet, phone, or in-person. Next the subscriber completes a validation questionnaire (502), which is offered in various formats such as paper, online, digital, or verbal. The questionnaire includes, but is not limited to, information regarding the subscriber's current carrier, name, billing address, phone number, cellular phone model, and whether the cellular phone is locked or unlocked. This information is then submitted for validation (503) and the subscriber information is validated (504). The purpose of validation includes, but is not limited to, ensuring subscriber information is correct and valid, determine whether carrier requirements are met, and determine outstanding balance and penalties, if any.

If validation is unsuccessful the user must re-enter the information (505) and restart the process (501) or end the process (506). If validation is successful the customer continues to the purchase process (507).

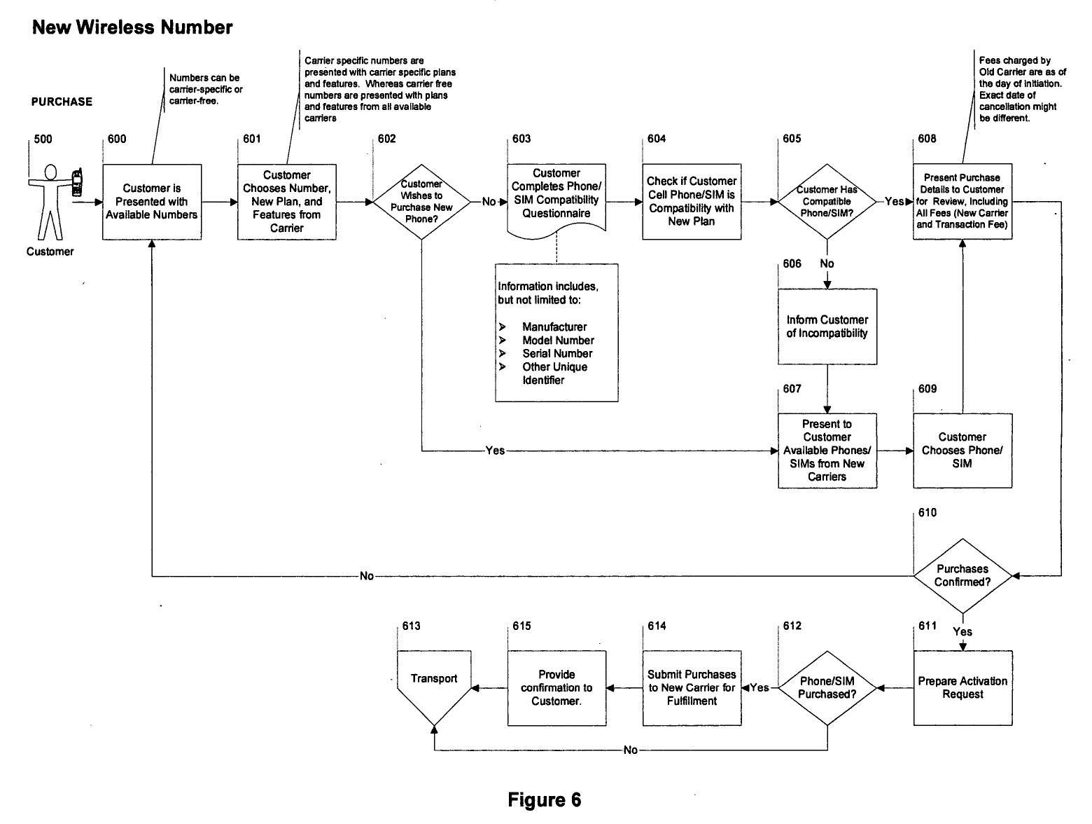

Now referring to FIG. 6 the purchase phase of a new portable wireless number is described. After completion of the validation process the customer (500) begins the purchase process by first being presented with available number (600). The numbers can be carrier specific or carrier-free. Next the subscriber chooses a number and new plan from the carrier (601). Carrier specific numbers are presented with carrier specific plans and features whereas carrier free numbers are presented with plans and features from all available carriers.

Next the customer is presented with the opportunity to purchase a new phone (602) and if they elect to purchase a new phone they are immediately presented with a list of available phones (607) and then make a phone selection (609). If the customer does not elect to purchase a new phone then they must complete a compatibility phone questionnaire (603). The compatibility phone questionnaire includes, but is not limited to information on the manufacturer, model number, serial number, and other unique phone identifiers. Next the customer's phone is checked for compatibility with the new carrier (604) and a compatibility decision is made (605). If the customer's phone is not compatible they are informed (606) and are presented with available phones from the provider (607). If the customer's phone is compatible present purchase details are presented to the customer for review (608), which includes new and old carrier transaction fees. The fees charged by the old carrier are as of the day of initiation and the exact cancellation date might be different.

Next the purchase is confirmed (610) and the user continues with activation and cancellation request (611). Finally the new phone purchase decision (612) is analyzed and if a new phone is not purchased the method of new phone portability proceeds immediately to the transport process (613), but if a new phone is purchased a submission is made to the new carrier to fulfill order (614) and confirmation (615) is provided to the subscriber.

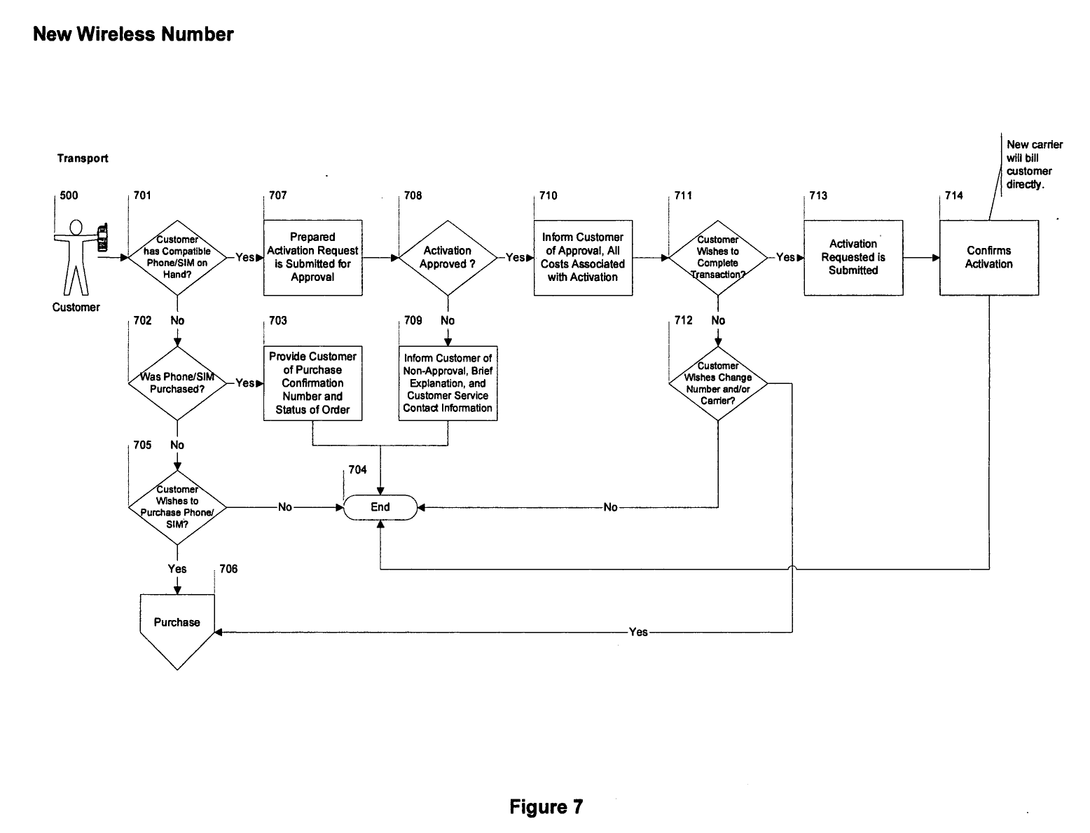

With the purchase process complete the final step is the transport process, which is described in FIG. 7. The transport process starts when the customer (500) has a compatible phone on hand (501). If the subscriber does not have the phone on hand they are first asked if they purchased a new phone (702), and, if they have, a confirmation number and order status update (703) is provided and the transport process ends (704) until a phone is received. If the subscriber had not purchased a phone they are asked if they wish to purchase a phone at this point (705). If the subscriber wishes to purchase a phone they are directed to the purchase process (706), but if they choose not to purchase a phone at this time the transport process ends (704).

If the customer has a phone the prepared activation application is submitted for approval (707) and an approval decision is made (708). If it is not approved the subscriber is informed of the non-approval (709) and the transport process ends (704). If it is approved the customer is informed of approval (710) and all costs associated with the transaction.

The customer must then decide to continue or terminate the transaction (711). If the customer does not wish to complete the transaction that can decide to select a new number or carrier (712) and return to the purchase process (706) or end the process (704). If the customer wishes to continue the transaction an activation request is submitted (713) and a confirmation (714) is issued upon approval and new carrier will bill the customer directly.

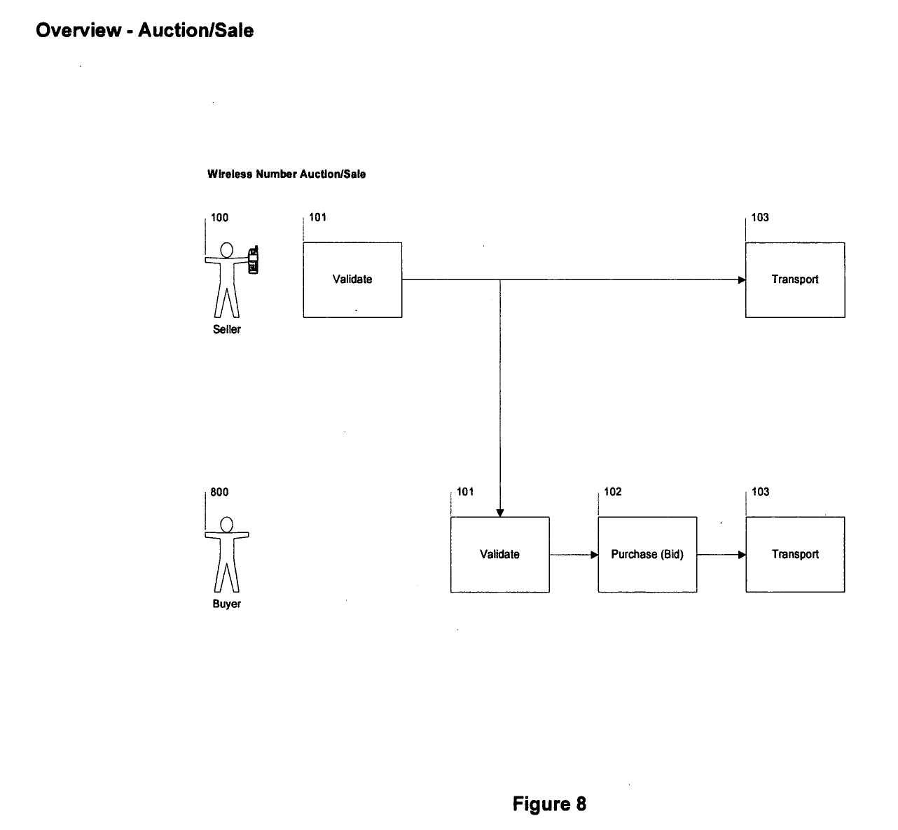

In yet another embodiment the same fundamental three-step process previously described and now illustrated with slight modifications in FIG. 8 can be used to conduct a wireless number auction or sale. A seller (100) or buyer (800) must first be validated (101). Once the seller is validated, the seller process continues directly to the transport process (103). However, the seller has the right to cancel the auction/sale anytime between the validation and the transport processes. A buyer (800), after being validated (101) would proceed to the purchase/bid process (102) in an attempt to procure a phone number, and if successful would finally proceed to the transport process (103) to complete the process of acquiring a new portable phone number and phone, if desired.

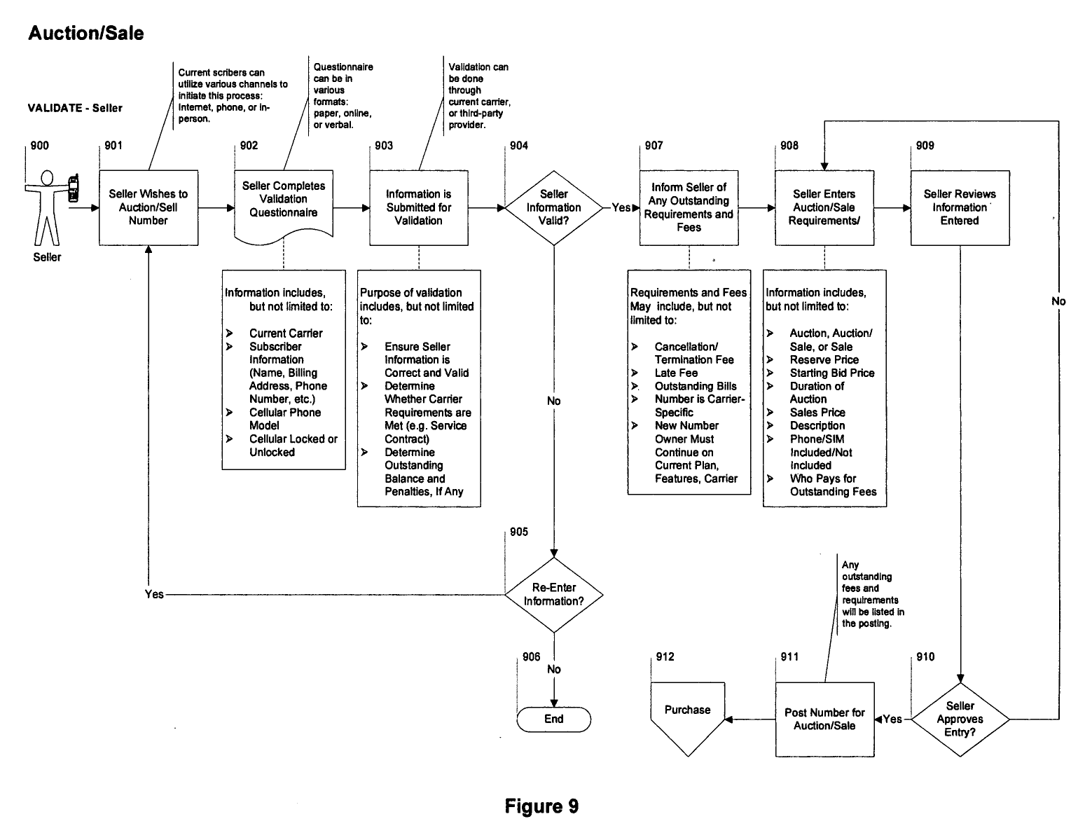

Now referring to FIG. 9 the seller's validation process is described. The seller (900) first decides to auction or sell their number (901), which can be accomplished by utilizing various channels to initiate the process such as the Internet, phone, or in-person. Next the seller completes a validation questionnaire (902), which is offered in various formats such as paper, online, digital, or verbal. The questionnaire includes, but is not limited to, information regarding the subscriber's current carrier, name, billing address, phone number, cellular phone model, and whether the cellular phone is locked or unlocked. This information is then submitted for validation (903) and the seller information is validated (904). The purpose of validation includes, but is not limited to, ensuring subscriber information is correct and valid, determine whether carrier requirements are met, and determine outstanding balance and penalties, if any.

If validation (904) is unsuccessful the seller must re-enter the information (905) and restart the process or end the process (906). If the validation (904) is successful the seller is informed of outstanding requirements and fees (907). Requirements and fees may include, but are not limited to: cancellation/termination fee, late fee, outstanding bills, number is carrier specific, new number owner must continue current plan, feature, or carrier. After success full validation and the seller enters an auction and lists sale requirements (908). Seller then reviews information (909) and has the option to approve or disapprove the entry (910). If the seller disapproves the entry, seller may return and change the auction and sale requirements. If the seller approves the entry the number is posted for sale (911). Any outstanding fees and requirements will be listed in the posting. Seller then enters the purchase process (912) while waiting for a buyer.

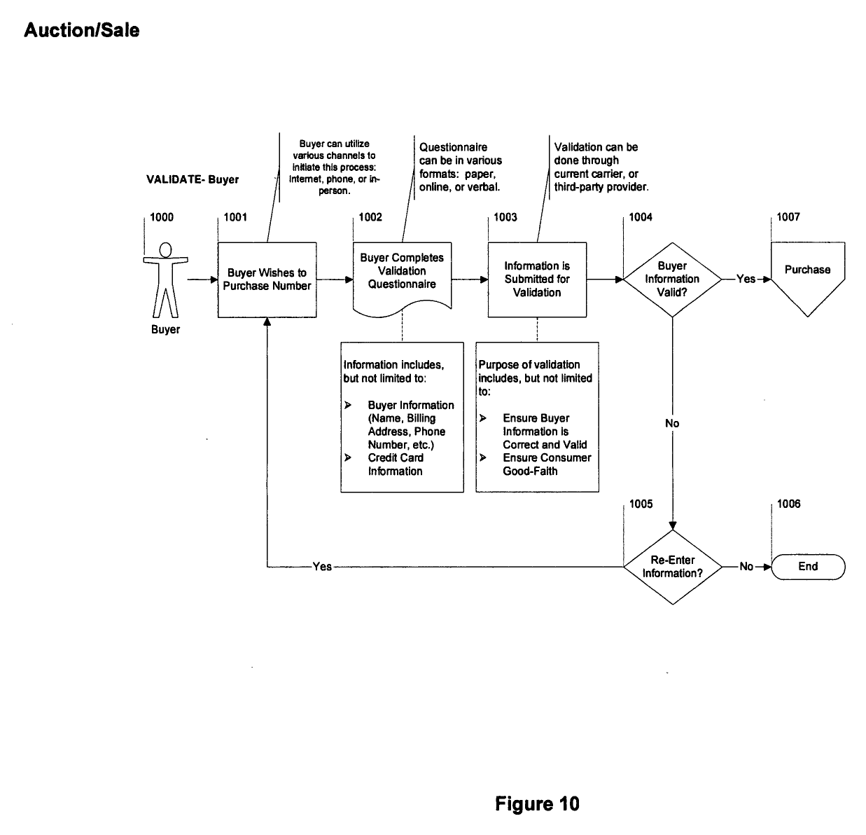

Now referring to FIG. 10 the buyer's validation process is described. The buyer (1000) first decides to purchase a number (1001), which can be accomplished by utilizing various channels to initiate the process such as the Internet, phone, or in-person. Next the buyer completes a validation questionnaire (1002), which is offered in various formats such as paper, online, digital, or verbal. The questionnaire includes, but is not limited to, information regarding the buyer's current carrier, name, billing address, phone number, cellular phone model, and whether the cellular phone is locked or unlocked. This information is then submitted for validation (1003) and the buyer information is validated (1004). The purpose of validation includes, but is not limited to, ensuring subscriber information is correct and valid, determine whether carrier requirements are met, and determine outstanding balance and penalties, if any. Validation can be done through a current carrier or third-party provider.

If validation is unsuccessful the user must re-enter the information (1005) and restart the process (1001) or end the process (1006). If validation is successful the customer continues to the purchase process (1007).

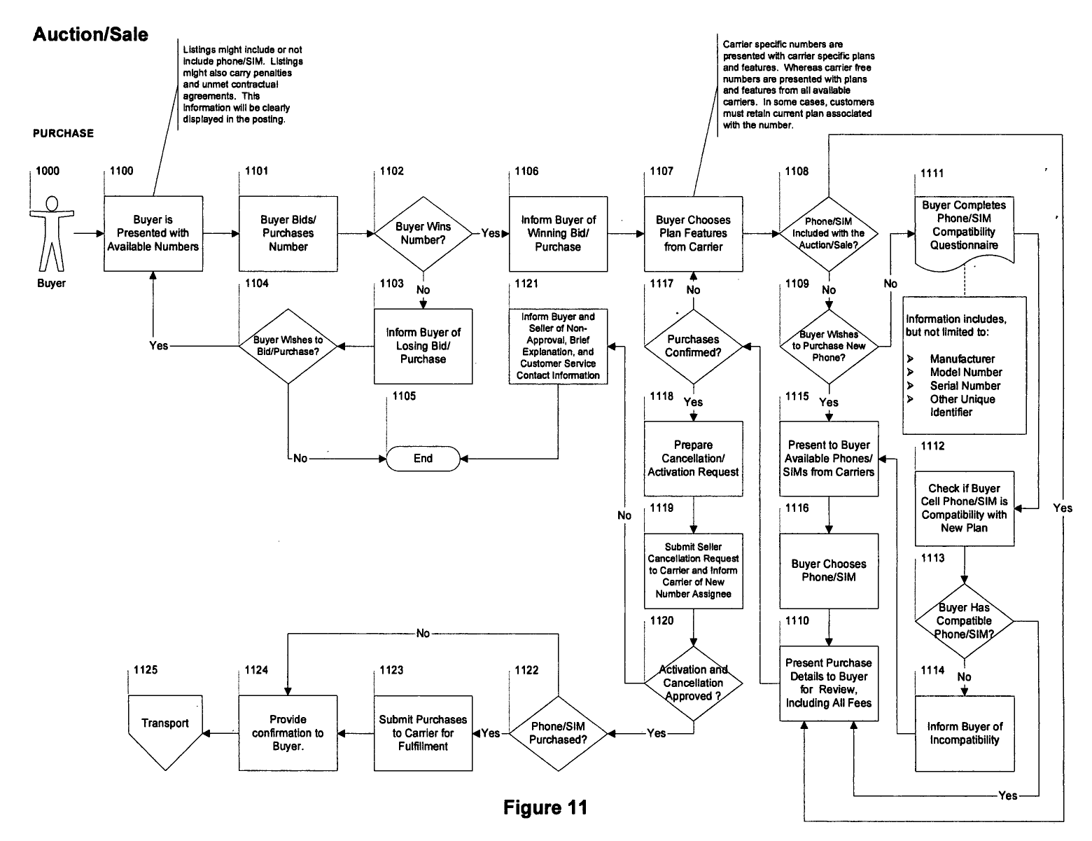

Now referring to FIG. 11 the purchase process for a buyer of a portable phone number is described. First a buyer (1000) is presented with available numbers (1100) which might include or note include a phone. Listings might also carry penalties and unmet contractual obligations. This information will be clearly displayed in the posting for sale. The buyer then purchases or places a bid for the number (1101), which the buyer may or may not win (1102). If the buyer loses, the buyer is informed of the loss (1103) and then may wish to make another bid (1104) or end the process (1105). If the buyer is received notification of a winning bid or purchase (1106) they then choose plan features from the carrier (1107). Carrier specific numbers are presented with carrier specific plans and features. Whereas carrier free numbers are presented with plans and features from all available carriers. In some cases, customers must retain the current plan associated with the number.

After selecting a plan the buyer then must find a phone (1108), which may or may not have been included in the auction (1109). If a phone was included in the auction the buyer immediately is presented with the details of his purchase for review (1110), which includes all fees. If no phone was included with the auction (1109) the buyer will either be presented with available phones from the carriers (1115) or to complete a compatibility phone questionnaire (1111) for a buyer's existing phone. The compatibility phone questionnaire includes, but is not limited to information on the manufacturer, model number, serial number, and other unique phone identifiers.

Next the buyer's phone is checked for compatibility with the new plan (1112) and a compatibility decision is made (1113). If the buyer's phone is not compatible they are informed (1114) and are presented with available phones from the provider (1115). If the customer's phone is compatible present purchase details the buyer selects the phone (1116) and purchase details are presented to the buyer for review (1110).

After the present purchase details are reviewed by the buyer (1110) the purchase is confirmed or denied (1117). If the purchase is denied the buyer still has the option to choose plan features from a carrier (1107). If the purchase is confirmed a cancellation activation request for the seller is prepared (1118). Next a seller cancellation request is submitted to carrier and the carrier is informed of the new number assignment (1119). The activation is then cancelled or approved (1120). If the activation is not approved the buyer and seller of informed of the non-approval (1121) and the process ends (1105). If the activation is approved the phone is purchases (1122) if required and the carrier is notified of the purchase for fulfillment (1123). Confirmation is then provided to the buyer (1124) and the transport process (1125) is initiated.

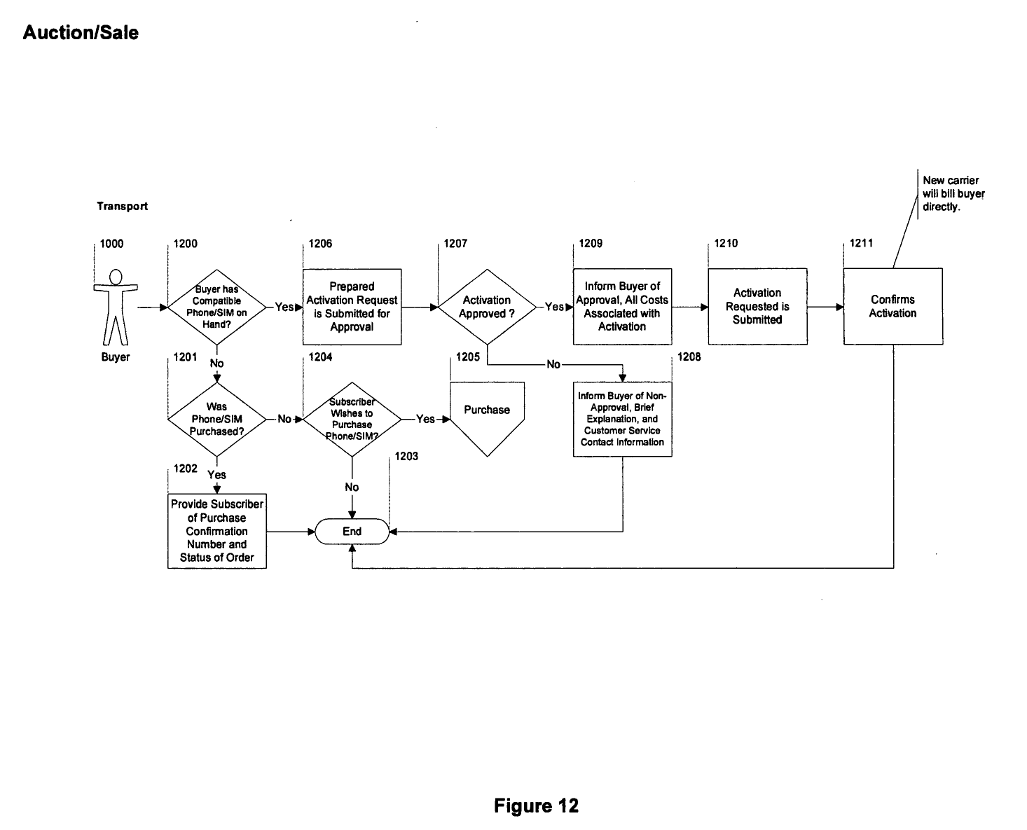

FIG. 12 illustrates the transport process of the wireless number auction/sale process. The transport process starts by determining whether the buyer (1000) has a compatible phone on hand (1200). If the buyer does not have the phone on hand they are first asked if they purchased a new phone (1201), if they have a confirmation number and order status update (1202) is provided and the transport process ends (1203) until a phone is received. If the buyer had not purchased a phone they are asked if they wish to purchase a phone at this point (1204). If the buyer wishes to purchase a phone they are directed to the purchase process (1205), but if they choose not to purchase a phone at this time the transport process ends (1203).

If the buyer has a phone the cancellation request is submitted and the activation process begins (1206). Next the application and cancellation must be approved (1207). If it is not approved the buyer is informed of the non-approval (1208) and the transport process ends (1203). If it is approved the subscriber is informed of approval (1209) and all costs associated with the transaction. Finally an activation request is submitted (1210) and the activation is confirmed (1211) and the new carrier will bill the buyer directly.

In addition, other areas of number portability may benefit from this method and adjustments to the process are anticipated. Thus, the scope of the invention should be determined by the appended claims and their legal equivalents, rather than by the examples given.

1. A method of enabling phone number portability between wireline to wireless and wireless to wireless systems comprising the steps of:
(a) process of validating a subscriber's information;
(b) process of enabling a subscriber to purchase a plan and phone;
(c) process of transporting to a subscriber a phone and plan information.

2. The method of claim 1 where the validation process further comprises the steps of:
(a) subscriber first decides to change carriers;
(b) subscriber completes a validation questionnaire;
(c) submitting questionnaire for validation and the subscriber information is validated;
(d) if validation is unsuccessful the user must re-enter the information and restart the process or end the process;
(e) if validation is successful the subscriber is informed of any outstanding requirements, fees, and counteroffers;
(f) subscriber decides whether to continue with the transaction and purchase, end the transaction, or accept any potential counter offers;

3. The method of claim 2 where the purchase process further comprises the steps of:
(a) After completion of the validation process the subscriber begins the purchase process by first being presented with available plans and features form other carries with the recommendation being made;
(b) subscriber chooses a new plan and features from the new carrier;
(c) subscriber then decides whether to purchase a new phone;
(d) if the subscriber elects to purchase a new phone they are presented with a list of available phones from the new carrier and then choose their new phone;
(e) if the subscriber does not elect to purchase a new phone then they must complete a compatibility phone questionnaire;
(f) next the subscriber's phone is checked for compatibility with the carrier and a compatibility decision is made;
(g) if the subscriber's phone is not compatible they are informed and are presented with available phones from the new provider;
(h) if the subscriber's phone is compatible present purchase details are presented to the subscriber for review;
(i) purchase is confirmed and the user continues with activation and cancellation request or returns to choose a new if they elect not to confirm their current selection;
(j) new phone purchase decision is analyzed and if a new phone is not purchased the subscriber proceeds immediately to the transport process;
(k) if a new phone is purchased a submission is made to the new carrier to fulfill order and confirmation is provided to the subscriber.

4. The method of claim 3 where the transport process further comprises the steps of:
(a) the transport process starts when the subscriber has a compatible phone on hand;
(b) if the subscriber does not have the phone on hand they are first asked if they purchased a new phone;
(c) if they have a confirmation number and order status update is provided and the transport process ends until a phone is received;
(d) if the subscriber had not purchased a phone they are asked if they wishes to purchase a phone at this point, if the subscriber wishes to purchase a phone they is directed to the purchase process but if subscriber chooses not to purchase a phone at this time the transport process ends;
(e) if the subscriber has a phone the cancellation request is submitted and the activation process begins;
(f) the activation and cancellation must be approved if it is not approved the subscriber is informed of the non-approval and the transport process ends, if it is approved the subscriber is informed of approval and all costs associated with the transaction;
(g) the subscriber must decide whether to complete the transaction, if the subscriber elects to complete the transaction the activation and cancellation requests are submitted and a confirmation is generated upon completion and the new and old carriers will bill subscriber directly, if the subscriber elects not to complete the transaction they is still able to accept any counter offers or select a new plan, if the subscriber does not wish to accept any other offers then the transport process ends, but if a new offer is accepted then the user must return to the validation process.

5. A method of enabling phone number portability of new wireless number comprising the steps of:
(a) process of validating a subscriber's information;
(b) process of enabling a subscriber to purchase a plan and phone;
(c) process of transporting to a subscriber a phone and plan information.

6. The method of claim 5 where the validation process further comprises the steps of:
(a) customer first decides to purchase a new wireless number;
(b) subscriber completes a validation questionnaire;
(c) validation questionnaire is then submitted for validation and the subscriber information is validated;
(d) if validation is unsuccessful the user must re-enter the information and restart the process or end the process, if validation is successful the customer continues to the purchase process.

7. The method of claim 6 where the purchase process further comprises the steps of:
(a) customer begins the purchase process by first being presented with available number, the numbers can be carrier specific or carrier-free;
(b) customer chooses a number and new plan from the carrier;
(c) customer is presented with the opportunity to purchase a new phone and if they elects to purchase a new phone, the customer is immediately presented with a list of available phones and then the customer makes a phone selection, if the customer does not elect to purchase a new phone then they must complete a compatibility phone questionnaire
(d) the customer's phone is checked for compatibility with the new carrier and a compatibility decision is made;
(e) if the customer's phone is not compatible they is informed and are presented with available phones from the provider, if the customer's phone is compatible present purchase details are presented to the customer for review;
(f) the purchase is confirmed and the user continues with activation and cancellation request;
(g) new phone purchase decision is analyzed, if a new phone is not purchased the method of new phone portability proceeds immediately to the transport process;
(h) if a new phone is purchased a submission is made to the new carrier to fulfill order and confirmation is provided to the customer.

8. The method of claim 7 where the transport process further comprises the steps of:
(a) transport process starts when the customer has a compatible phone on hand;
(b) if the customer does not have the phone on hand they is first asked if a new phone was purchased;
(c) if customer has phone on hand, a confirmation number and order status update is provided and the transport process ends until a phone is received;
(d) if the subscriber had not purchased a phone they is asked if they wish to purchase a phone at this point, if the subscriber wishes to purchase a phone they are directed to the purchase process but if they choose not to purchase a phone at this time the transport process ends;
(e) if the customer has a phone the prepared activation request is submitted for approval and an approval decision is made;
(f) if not approved the subscriber is informed of the non-approval and the transport process ends, if approved the customer is informed of approval and all costs associated with the transaction;
(g) the customer must then decide to continue or terminate the transaction, if the customer does not wish to complete the transaction that can decide to select a new number or carrier and return to the purchase process or end the process, if the customer wishes to continue the transaction an activation request is submitted and a confirmation is issued upon approval and new carrier will bill the customer directly.

9. A method of enabling phone number portability of phone numbers utilizing an auction or sale process comprising the steps of:
(a) process of validating a seller's information;
(b) process of validating a buyer's information;
(c) process of enabling a seller to purchase a plan and phone;
(d) process of enabling a buyer to purchase a plan and phone;
(e) process of transporting to a buyer or seller a phone and plan information.

10. The method of claim 9 where the seller's validation process further comprises the steps of:
(a) seller first decides to auction or sell their number;
(b) seller completes a validation questionnaire;
(c) validation questionnaire is then submitted for validation and the seller information is validated,
(d) if validation is unsuccessful the seller must re-enter the information and restart the process or end the process, if the validation is successful the seller is informed of outstanding requirements;
(e) after successful validation and the seller enters an auction and lists sale requirements;
(f) seller then reviews information and then has the option to approve or disapprove the entry;
(g) if the seller disapproves the entry, seller may return and change the auction and sale requirements, if the seller approves the entry the number is posted for;
(h) seller then enters the purchase process and waits for a buyer.

11. The method of claim 10 where the buyer's validation process further comprises the steps of:
(a) buyer first decides to purchase a number;
(b) buyer completes a validation questionnaire;
(c) validation questionnaire is then submitted for validation and the buyer information is validated, if validation is unsuccessful the user must re-enter the information and restart the process or end the process, if validation is successful the customer continues to the purchase process.

12. The method of claim 10 or 11 where the purchase process further comprises the steps of:
(a) buyer is presented with available numbers;
(b) buyer then purchases or places a bid for the number, if the buyer loses, they is informed of the loss and then may wish to make another bid or end the process;
(c) if the buyer is received notification of a winning bid or purchase they then chooses plan features from the carrier;
(d) if a phone was included in the auction the buyer immediately is presented with the details of his purchase for review;
(e) if no phone was included with the auction the buyer will either be presented with available phones from the carriers or to complete a compatibility phone questionnaire for a buyer's existing phone.
(f) the buyer's phone is checked for compatibility with the new plan and a compatibility decision is made;
(g) if the buyer's phone is not compatible they are informed and are presented with available phones from the provider, if the customer's phone is compatible present purchase details the buyer selects the phone and purchase details are presented to the buyer for review;
(h) present purchase details are reviewed by the buyer
(i) the purchase is confirmed or denied;
(j) If the purchase is denied the buyer still has the option to choose plan features from a carrier, if the purchase is confirmed a cancellation activation request for the seller is prepared;
(k) seller cancellation request is submitted to carrier and the carrier is informed of the new number assignment;
(l) activation is then cancelled or approved,
(m) if the activation is not approved the buyer and seller of informed of the non-approval and the process ends, if the activation is approved the phone is purchases if required and the carrier is notified of the purchase for fulfillment;
(n) confirmation is then provided to the buyer and the transport process is initiated.

13. The method of claim 12 where the transport process further comprises the steps of:
(a) the transport process starts by determining whether the buyer has a compatible phone on hand;
(b) if the buyer does not have the phone on hand they are first asked if they purchased a new phone, if they have a confirmation number an order status update is provided and the transport process ends until a phone is received, if the buyer had not purchased a phone they are asked if they wish to purchase a phone at this point; if the buyer wishes to purchase a phone they are directed to the purchase process but if they choose not to purchase a phone at this time the transport process ends;
(c) if the buyer has a phone the cancellation request is submitted and the activation process begins;
(d) the application and cancellation must be submitted for approval, if the application is not approved the buyer is informed of the non-approval and the transport process ends, if it is approved the subscriber is informed of approval and all costs associated with the transaction;
(e) an activation request is submitted and the activation is confirmed;
(f) the new carrier will bill the buyer directly.

14. The method of claims 1-13 further comprising:
the ability to process number portability transactions that are not related directly through any specific carriers.

15. The method of claims 5-8 further comprising:
the ability for a user to choose a desired phone number, of which the phone numbers could be carrier-specific or carrier-free when purchasing wireless services.
